(19) United States
(12) Patent Application Publication
(10) Pub. No.: US 2025/0079497 A1
(43) Pub. Date: Mar. 6, 2025

(54) ENERGY STORAGE DEVICE AND ENERGY STORAGE APPARATUS

(71) Applicant: GS Yuasa International Ltd., Kyoto-shi, Kyoto (JP)

(72) Inventors: Yuto YAMAKAWA, Kyoto (JP); Takashi OKAJIMA, Kyoto (JP)

(21) Appl. No.: 18/580,488

(22) PCT Filed: Jun. 23, 2022
(86) PCT No.: PCT/JP2022/025112

§ 371 Date: Jan. 18, 2024

(30) Foreign Application Priority Data
Jul. 27, 2021 (JP) 2021-122805
Jul. 27, 2021 (JP) 2021-122806

(51) Int. Cl. H01M 10/04; H01G 11/30; H01M 4/36; H01M 10/058

(52) U.S. Cl. CPC H01M 10/0468; H01M 4/366; H01M 10/058; H01G 11/30

(57) ABSTRACT

An energy storage device according to one aspect of the present invention includes an electrode assembly in which a positive electrode and a negative electrode are stacked with a separator interposed therebetween, in which the electrode assembly is in a state where a load is applied to the electrode assembly in a stacking direction, the positive electrode contains a positive active material, tungsten, boron, sulfur, phosphorus, silicon, titanium, nitrogen, germanium, aluminum, zirconium or a different element which is a combination thereof is present on a surface of the positive active material, and a creep strain after a load of 2 MPa is held for 60 seconds at a temperature of 65° C. in the separator is 0.20 or less.

### TECHNICAL FIELD

The present invention relates to an energy storage device and an energy storage apparatus.

### BACKGROUND ART

Nonaqueous electrolyte secondary batteries typified by lithium ion secondary batteries are often used for electronic devices such as personal computers and communication terminals, motor vehicles, and the like since, because the batteries are high in energy density. Also, capacitors such as lithium ion capacitors and electric double-layer capacitors, energy storage devices with electrolytes other than nonaqueous electrolyte used, and the like are also widely used as energy storage devices other than nonaqueous electrolyte secondary batteries.

As a positive active material used in such an energy storage device, a positive active material capable of reducing internal resistance and improving cycle performance by coating the surface of the positive active material with a metal oxide has been proposed (see Patent Document 1).

### PRIOR ART DOCUMENT

### Patent Document

Patent Document 1: JP-A-2009-076279

### SUMMARY OF THE INVENTION

### Problems to be Solved by the Invention

In such an energy storage device, an increase in DC resistance is large particularly when charging and discharging are repeated at a high temperature, and it is required to suppress the increase in DC resistance associated with a charge-discharge cycle at a high temperature.

An object of the present invention is to provide an energy storage device in which an increase in DC resistance associated with a charge-discharge cycle at a high temperature is suppressed, and an energy storage apparatus.

### Means for Solving the Problems

An energy storage device according to one aspect of the present invention includes an electrode assembly in which a positive electrode and a negative electrode are stacked with a separator interposed therebetween, in which the electrode assembly is in a state where a load is applied to the electrode assembly in a stacking direction, the positive electrode contains a positive active material, tungsten, boron, sulfur, phosphorus, silicon, titanium, nitrogen, germanium, aluminum, zirconium or a different element which is a combination thereof is present on a surface of the positive active material, and a creep strain after a load of 2 MPa is held for 60 seconds at a temperature of 65° C. in the separator is 0.20 or less.

An energy storage apparatus according to another aspect of the present invention includes two or more energy storage devices, and one or more energy storage devices according to the other aspect of the present invention.

### Advantages of the Invention

According to one aspect of the present invention, it is possible to provide an energy storage device in which an increase in DC resistance associated with a charge-discharge cycle at a high temperature is suppressed, and according to another aspect of the present invention, it is possible to provide an energy storage apparatus in which the increase in DC resistance associated with the charge-discharge cycle at a high temperature is suppressed.

### BRIEF DESCRIPTION OF THE DRAWINGS

FIG. 1 is a see-through perspective view illustrating an embodiment of an energy storage device.

FIG. 2 is a schematic diagram illustrating an embodiment of an energy storage apparatus including a plurality of the energy storage devices assembled.

### MODE FOR CARRYING OUT THE INVENTION

### Item 1.

An energy storage device according to an embodiment of the present invention includes an electrode assembly in which a positive electrode and a negative electrode are stacked with a separator interposed therebetween, in which
the electrode assembly is in a state where a load is applied in a stacking direction,
the positive electrode contains a positive active material,
tungsten, boron, sulfur, phosphorus, silicon, titanium, nitrogen, germanium, aluminum, zirconium or a different element which is a combination thereof is present on a surface of the positive active material, and
a creep strain after a load of 2 MPa is held for 60 seconds at a temperature of 65° C. in the separator is 0.20 or less.

According to the energy storage device described in item 1, it is possible to suppress an increase in DC resistance associated with a charge-discharge cycle at a high temperature.

### Item 2.

In the energy storage device described in item 1, a pressure applied to the electrode assembly may be 0.1 MPa or more.

According to the energy storage device described in item 2, it is possible to further suppress the increase in DC resistance associated with the charge-discharge cycle at a high temperature.

### Item 3.

In the energy storage device described in item 1 or 2, the content of the different element may be 0.1 mol % or more and 3.0 mol % or less with respect to lithium and a metal element other than the different element contained in the positive active material.

According to the energy storage device described in item 3, it is possible to further improve the effect of suppressing the increase in DC resistance associated with the charge-discharge cycle at a high temperature.

### Item 4.

In the energy storage device described in item 1, item 2 or item 3, the separator may include a substrate layer, the positive electrode may include a positive active material layer containing the positive active material, and an inorganic layer may be disposed between the positive active material layer and the substrate layer.

According to the energy storage device described in item 4, initial DC resistance can also be reduced.

### Item 5.

An energy storage apparatus according to another embodiment of the present invention may be an energy storage apparatus including two or more energy storage devices and one or more energy storage devices described in any one of items 1 to 4.

According to the energy storage apparatus device described in item 5, it is possible to suppress an increase in DC resistance associated with a charge-discharge cycle at a high temperature.

First, outlines of an energy storage device and an energy storage apparatus disclosed in the present specification will be described.

An energy storage device according to one aspect of the present invention includes an electrode assembly in which a positive electrode and a negative electrode are stacked with a separator interposed therebetween, in which the electrode assembly is in a state where a load is applied to the electrode assembly in a stacking direction, the positive electrode contains a positive active material, tungsten, boron, sulfur, phosphorus, silicon, titanium, nitrogen, germanium, aluminum, zirconium or a different element which is a combination thereof is present on a surface of the positive active material, and a creep strain after a load of 2 MPa is held for 60 seconds at a temperature of 65° C. in the separator is 0.20 or less.

The energy storage device can suppress an increase in DC resistance associated with a charge-discharge cycle at a high temperature. Although the reason therefor is not clear, the following reason is presumed. In the energy storage device, the surface of the positive active material has tungsten, boron, sulfur, phosphorus, silicon, titanium, nitrogen, germanium, aluminum, zirconium, or a different element which is a combination thereof, so that ion conductivity of the surface of the positive active material is increased, and reaction resistance of the positive active material is reduced. Since the creep strain after a load of 2 MPa is held for 60 seconds at a temperature of 65° C. in the separator under a state where a load is applied to the electrode assembly in the stacking direction is 0.20 or less, a contact between the positive active material and the different element present on the surface of the positive active material can be favorably maintained even when the charge-discharge cycle is performed at a high temperature. Therefore, it is presumed that the energy storage device can suppress the increase in DC resistance associated with the charge-discharge cycle at a high temperature. Here, the different element may be present on at least a part of the surface of the positive active material, and may be contained not only on the surface of the positive active material but also inside the positive active material. When the different element is present on the surface and inside the positive active material, the content of each different element present on the surface and inside the positive active material is 4.0 mol % or less with respect to lithium and a metal element other than the different element contained in the positive active material. That is, when the positive active material contains any element of tungsten, boron, sulfur, phosphorus, silicon, titanium, nitrogen, germanium, aluminum, and zirconium in an amount of more than 4.0 mol % with respect to lithium and the metal element other than the different element contained in the positive active material, the element is not contained in the different elements.

The pressure applied to the electrode assembly is preferably 0.1 MPa or more. When the pressure is 0.1 MPa or more, the increase in DC resistance associated with the charge-discharge cycle can be further suppressed. Here, the pressure applied to the electrode assembly is a value measured by the following method.

(i) Case where Load is Applied to Energy Storage Device by Pressurizing Member, Etc.

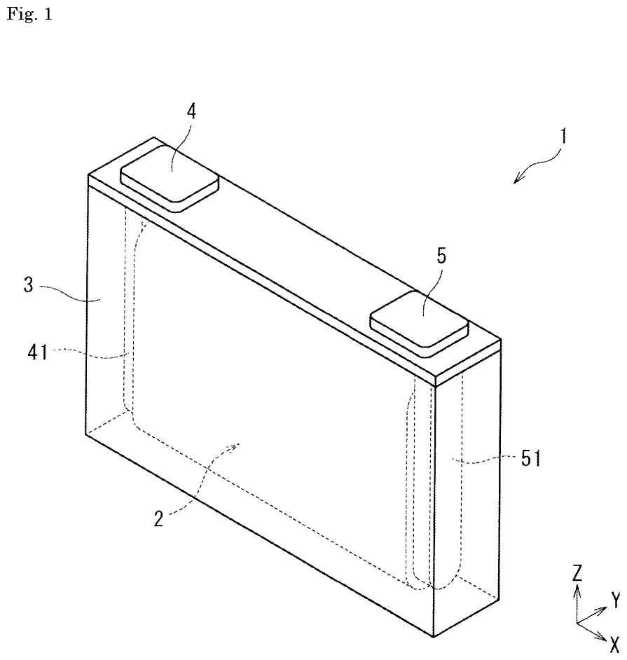

First, in a state where a load is applied by a pressurizing member or the like, the energy storage device is discharged at a constant current to a lower limit voltage under normal usage at a discharge current of 0.2 C, and then installed in an X-ray computed tomography (CT) apparatus. The term “under normal usage” means use of the energy storage device while employing charge discharge conditions recommended or specified in the energy storage device. Scanning is performed along a direction parallel to the stacking direction (Y direction in FIG. 1) of the electrode assembly to check whether or not at least a part of a surface of the electrode assembly to which a load is applied (usually, a plane orthogonal to the stacking direction of the electrode assembly, an XZ plane in FIG. 1) is in direct or indirect contact with an inner surface of the case. When the surface of the electrode assembly to which the load is applied is not in direct or indirect contact with the inner surface of the case, the pressure applied to the electrode assembly is set to 0 MPa. When the surface of the electrode assembly to which the load is applied is in direct or indirect contact with the inner surface of the case, the load applied to the electrode assembly is measured using an autograph in the following procedure. The energy storage device to which the load is applied by the pressurizing member or the like is installed on an autograph so that a probe is in contact with the surface of the electrode assembly to which the load is applied. A load sufficiently smaller than the load by the pressurizing member or the like is applied to the energy storage device in the stacking direction (Y direction in FIG. 1) of the energy storage devices by the autograph. In this state, the load applied by the pressurizing member or the like is released while the probe position of the autograph is maintained, that is, while the thickness of the energy storage device is maintained. At this time, an amount of change in the load measured by the autograph is defined as the load applied to the electrode assembly. A value obtained by dividing the load applied to the electrode assembly by an area of a contact surface between the case and the electrode assembly is defined as a pressure applied to the electrode assembly. Usually, a load is applied to a pair of opposing surfaces of the energy storage device by the pressurizing member or the like, and an area of only one surface of the pair of surfaces is defined as an area of a surface to which the load is applied.

(ii) Case where No Load is Applied to Energy Storage Device by Pressurizing Member, Etc.

In a case where, while the energy storage device is restrained by the restraining member and the like, no load is applied by the restraining member and the like, the pressure applied to the electrode assembly is measured by the following procedure. First, the energy storage device is discharged at a constant current to the lower limit voltage under normal usage at a discharge current of 0.2 C, and then installed in an X-ray CT apparatus. Scanning is performed along the direction parallel to the stacking direction (Y direction in FIG. 1) of the electrode assembly to check whether or not at least a part of the plane (XZ plane in FIG. 1) orthogonal to the stacking direction of the electrode assembly is in direct or indirect contact with the inner surface of the case. When the surface of the electrode assembly, which is orthogonal to the stacking direction, is not in direct or indirect contact with the inner surface of the case, the pressure applied to the electrode assembly is set to 0 MPa. When the surface of the electrode assembly, which is orthogonal to the stacking direction, is in direct or indirect contact with the inner surface of the case, an X-ray transmission image of the electrode assembly is captured, and the maximum thickness of the electrode assembly in the stacking direction is measured. The energy storage device is disassembled to take out the electrode assembly, and the electrode assembly is installed in the autograph so that the probe is in contact with a plane orthogonal to the stacking direction of the electrode assembly. A load is gradually applied to the plane orthogonal to the stacking direction of the electrode assembly by the autograph, and the electrode assembly is compressed to the maximum thickness in the thickness direction of the electrode assembly measured from an X-ray transmission image. At this time, the load measured by the autograph is defined as a load applied to the electrode assembly. The value obtained by dividing the load applied to the electrode assembly by the area of the contact surface between the case and the electrode assembly is defined as the pressure applied to the electrode assembly. Usually, a load is applied to the pair of opposing surfaces of the electrode assembly by the case, and the area of only one surface of the pair of surfaces is defined as the area of the surface to which the load is applied.

The content of the different element is preferably 0.1 mol % or more and 3.0 mol % or less with respect to lithium and a metal element other than the different element contained in the positive active material. When the content of the different element is within the above range with respect to lithium and the metal element other than the different element contained in the positive active material, it is possible to further improve the effect of suppressing the increase in DC resistance associated with the charge-discharge cycle of the energy storage device at a high temperature. When there are a plurality of different elements, the content of the different elements is the content of each different element.

It is preferable that the separator includes a substrate layer, the positive electrode includes a positive active material layer containing the positive active material, and an inorganic layer is disposed between the positive active material layer and the substrate layer. When an inorganic layer harder than the substrate layer is disposed between the positive active material layer and the substrate layer in the state where the load is applied to the electrode assembly in the stacking direction, the contact between the positive active material and the different element present on the surface of the positive active material can be favorably maintained. Accordingly, initial DC resistance of the energy storage device can also be reduced.

An energy storage apparatus according to another aspect of the present invention includes two or more energy storage devices, and one or more energy storage devices according to the other aspect of the present invention.

Since the energy storage apparatus includes the energy storage device in which the increase in DC resistance associated with the charge-discharge cycle at a high temperature is suppressed, the increase in DC resistance associated with the charge-discharge cycle at a high temperature can be suppressed.

The configuration of an energy storage device, the configuration of an energy storage apparatus, and a method for manufacturing the energy storage device according to an embodiment of the present invention, and other embodiments will be described in detail. It is to be noted that the names of the respective constituent members (respective constituent elements) for use in the respective embodiments may be different from the names of the respective constituent members (respective elements) for use in the background art.

### <Configuration of Energy Storage Device>

An energy storage device according to an embodiment of the present invention includes: an electrode assembly including a positive electrode, a negative electrode, and a separator; a nonaqueous electrolyte; and a case that houses the electrode assembly and the nonaqueous electrolyte. The electrode assembly is typically a stacked type obtained by stacking a plurality of positive electrodes and a plurality of negative electrodes with separators interposed therebetween, or a wound type obtained by winding a positive electrode and a negative electrode stacked with a separator interposed therebetween. The nonaqueous electrolyte is present in a state of being contained in the positive electrode, the negative electrode, and the separator. A nonaqueous electrolyte secondary battery (hereinafter, also referred to simply as a “secondary battery”) will be described as an example of the energy storage device.

### (Positive Electrode)

The positive electrode includes a positive substrate and a positive active material layer disposed directly on the positive substrate or over the positive substrate with an intermediate layer interposed therebetween.

The positive substrate has conductivity. Whether the positive substrate has “conductivity” or not is determined with the volume resistivity of 10⁷ Ω·cm measured in accordance with JIS-H-0505 (1975) as a threshold. As the material of the positive substrate, a metal such as aluminum, titanium, tantalum, or stainless steel, or an alloy thereof is used. Among these metals and alloys, aluminum or an aluminum alloy is preferable from the viewpoints of electric potential resistance, high conductivity, and cost. Examples of the positive substrate include a foil, a deposited film, a mesh, and a porous material, and a foil is preferable from the viewpoint of cost. Accordingly, the positive substrate is preferably an aluminum foil or an aluminum alloy foil. Examples of the aluminum or aluminum alloy include A1085, A3003, and A1N30 specified in JIS-H-4000 (2014) or JIS-H-4160 (2006).

The average thickness of the positive substrate is preferably 3 μm or more and 50 μm or less, more preferably 5 μm or more and 40 μm or less, still more preferably 8 μm or more and 30 μm or less, and particularly preferably 10 μm or more and 25 μm or less. By setting the average thickness of the positive substrate to the above range, it is possible to increase the energy density per volume of a secondary battery while increasing the strength of the positive substrate.

The intermediate layer is a layer disposed between the positive substrate and the positive active material layer. The intermediate layer includes a conductive agent such as carbon particles to reduce contact resistance between the positive substrate and the positive active material layer. The configuration of the intermediate layer is not particularly limited, and includes, for example, a binder and a conductive agent.

The positive active material layer includes a positive active material. The positive active material layer contains optional components such as a conductive agent, a binder (binding agent), a thickener, a filler, or the like as necessary.

The positive active material can be appropriately selected from known positive active materials. As the positive active material for a lithium ion secondary battery, a material capable of occluding and releasing lithium ions is typically used. Examples of the positive active material include lithium-transition metal composite oxides that have an α-NaFeO₂-type crystal structure, lithium-transition metal composite oxides that have a spinel-type crystal structure, polyanion compounds, chalcogenides, and sulfur. Examples of the lithium-transition metal composite oxides that have an α-NaFeO₂-type crystal structure include Li[LiₓNi₍₁₋ₓ₎]O₂ (0≤x<0.5), Li[LiₓNi_{γ}Co_{(1-x-γ)}]O₂ (0≤x<0.5, 0<γ<1), Li[LiₓCo₍₁₋ₓ₎]O₂ (0≤x<0.5), Li[LiₓNi_{γ}Mn_{(1-x-γ)}]O₂ (0≤x<0.5, 0<γ<1), Li[LiₓNi_{γ}Mn_{β}Co_{(1-x-γ-β)}]O₂ (0≤x<0.5, 0<γ, 0<β, 0.5<γ+β<1), and Li[LiₓNi_{γ}CoBAl_{(1-x-γ-β)}]O₂ (0≤x<0.5, 0<γ, 0<β, 0.5<γ+β<1). Examples of the lithium-transition metal composite oxides that have a spinel-type crystal structure include LiₓMn₂O₄ and LiₓNi_{γ}Mn_{(2-γ)}O₄. Examples of the polyanion compounds include LiFePO₄, LiMnPO₄, LiNiPO₄, LiCOPO₄, Li₃V₂(PO₄)₃, Li₂MnSiO₄, and Li₂CoPO₄F. Examples of the chalcogenides include a titanium disulfide, a molybdenum disulfide, and a molybdenum dioxide. Some of atoms or polyanions in these materials may be substituted with atoms or anion species composed of other elements. The surfaces of these materials may be coated with other materials. In the positive active material layer, one of these materials may be used singly, or two or more thereof may be used in mixture.

The positive active material is preferably a lithium transition metal composite oxide, more preferably a lithium transition metal composite oxide containing at least one of nickel, cobalt, and manganese, still more preferably a lithium transition metal composite oxide containing at least two of nickel, cobalt, aluminum, and manganese, and even more preferably a lithium transition metal composite oxide containing nickel, cobalt and manganese, or a lithium transition metal composite oxide containing nickel, cobalt, and aluminum. The lithium transition metal composite oxide preferably has an α-NaFeO₂-type crystal structure. By using such a lithium transition metal composite oxide, the energy density can be increased, and the like.

The lithium transition metal composite oxide is preferably a compound represented by the following formula 1.

Li_{1+α}Me_{1-α}O₂ 1

In the formula 1, Me is a metal including at least one of Ni, Co and Mn (excluding Li). The condition of 0≤α<1 is met.

Me in the formula 1 preferably contains at least two of Ni, Co, Mn, and Al, more preferably contains Ni, Co, and Mn, or more preferably contains Ni, Co, and Al, and still more preferably composed substantially of three elements of Ni, Co, and Mn, or three elements of Ni, Co, and Al. However, Me may contain other metals. Me is also preferably a transition metal element containing at least one of Ni, Co, and Mn.

From the viewpoint of further increasing electric capacity and the like, a preferred content (composition ratio) of each constituent element in the compound represented by the formula 1 is as follows. It is to be noted that the molar ratio is equal to the atomic number ratio.

In the formula 1, the lower limit of the molar ratio (Ni/Me) of Ni to Me is preferably 0.1, and more preferably 0.2 or 0.3 in some cases. In contrast, the upper limit of the molar ratio (Ni/Me) is preferably 0.9, and more preferably 0.8, 0.7, 0.6, 0.5, or 0.4 in some cases.

In the formula 1, the lower limit of the molar ratio (Co/Me) of Co to Me is preferably 0.05, and more preferably 0.1, 0.2, or 0.3 in some cases. In contrast, the upper limit of the molar ratio (Co/Me) is preferably 0.7, and more preferably 0.5 or 0.4 in some cases.

In the formula 1, the lower limit of the molar ratio of Mn to Me (Mn/Me) is preferably 0.05, and more preferably 0.1, 0.2, or 0.3 in some cases. In contrast, the upper limit of the molar ratio (Mn/Me) is preferably 0.6, and more preferably 0.5 or 0.4 in some cases.

In the formula 1, the molar ratio of Al to Me (Al/Me) is preferably more than 0.04, and more preferably 0.05 or more in some cases. In contrast, the upper limit of the molar ratio (Al/Me) is preferably 0.20, and more preferably 0.10 or 0.08 in some cases.

In the formula 1, the upper limit of the molar ratio of Li to Me (Li/Me), i.e. (1+α)/(1−α) is preferably 1.6, and more preferably 1.4 or 1.2 in some cases.

The composition ratio of the lithium transition metal composite oxide refers to a composition ratio in the case of a completely discharged state provided by the following method. First, the energy storage device is subjected to constant current discharge at a discharge current of 0.05 C to the lower limit voltage under normal usage. After the battery is disassembled to take out the positive electrode, a test battery using metal Li as the counter electrode is assembled, constant current discharge is performed at a discharge current of 10 mA per 1 g of a positive active material until the positive potential reaches 3.0 V vs. Li/Li⁺, and the positive electrode is adjusted to the completely discharged state. The battery is disassembled again, and the positive electrode is taken out. Components (electrolyte and the like) attached on the positive electrode taken out are sufficiently washed off with dimethyl carbonate and is dried at room temperature for 24 hours, and the lithium-transition metal composite oxide of the positive active material is then collected. The collected lithium transition metal composite oxide is subjected to measurement. The operations from the disassembly of the energy storage device to the collection of the lithium transition metal composite oxide for measurement are performed in an argon atmosphere at a dew point of −60° C. or lower.

Examples of suitable lithium transition metal composite oxides include LiNi_{1/3}Co_{1/3}Mn_{1/3}O₂, LiNi_{3/5}Co_{1/5}Mn_{1/5}O₂, LiNi_{1/2}Co_{1/5}Mn_{3/10}O₂, LiNi_{1/2}Co_{3/10}Mn_{1/5}O₂, LiNi_{8/10}Co_{1/10}Mn_{1/10}O₂, and LiNi_{0.80}Co_{0.15}Al_{0.05}O₂.

The positive active material is usually a particle (powder). The average particle size of the positive active material is preferably 0.1 μm or more and 20 μm or less, for example. By setting the average particle size of the positive active material to be equal to or more than the lower limit mentioned above, the positive active material is easily manufactured or handled. By setting the average particle size of the positive active material to be equal to or less than the upper limit mentioned above, the electron conductivity of the positive active material layer is improved. In the case of using a composite of the positive active material and another material, the average particle size of the composite is regarded as the average particle size of the positive active material. The “average particle size” means a value at which a volume-based integrated distribution calculated in accordance with JIS-Z-8819-2 (2001) is 50% based on a particle size distribution measured by a laser diffraction/scattering method for a diluted solution obtained by diluting particles with a solvent in accordance with JIS-Z-8825 (2013).

A crusher, a classifier, or the like is used in order to obtain a powder with a predetermined particle size. Examples of the crushing method include a method of using a mortar, a ball mill, a sand mill, a vibratory ball mill, a planetary ball mill, a jet mill, a counter jet mill, a whirling airflow-type jet mill, a sieve, or the like. At the time of crushing, wet-type crushing in coexistence of water or an organic solvent such as hexane can also be used. As a classification method, a sieve or a wind force classifier or the like is used based on the necessity both in dry manner and in wet manner.

The content of the positive active material in the positive active material layer is preferably 50% by mass or more and 99% by mass or less, more preferably 70% by mass or more and 98% by mass or less, and still more preferably 80% by mass or more and 95% by mass or less. By setting the content of the positive active material in the above range, it is possible to achieve both high energy density and productivity of the positive active material layer.

In the energy storage device, the surface of the positive active material has tungsten, boron, sulfur, phosphorus, silicon, titanium, nitrogen, germanium, aluminum, zirconium, or a different element which is a combination thereof. In the energy storage device, the presence of the different element on the surface of the positive active material increases the ion conductivity of the surface of the positive active material, and the reaction resistance of the positive active material is reduced. Among the different elements, tungsten, boron, silicon, titanium, nitrogen, germanium, aluminum, zirconium, or a combination thereof is preferable in that the ion conductivity of the surface of the positive active material is further increased and the reaction resistance of the positive active material is further reduced, and tungsten, boron, or a combination thereof is more preferable. The different element may be present on at least a part of the surface of the positive active material, and may be contained not only on the surface of the positive active material but also inside the positive active material, or may be present only on the surface. The different element may be solid-solved in the positive active material, or may be present as a compound different from the positive active material on the surface of the positive active material. When the different element is present on the surface and inside the positive active material, the content of each different element present on the surface and inside the positive active material is 4.0 mol % or less with respect to lithium and the metal element other than the different element contained in the positive active material. That is, when the positive active material contains any element of tungsten, boron, sulfur, phosphorus, silicon, titanium, nitrogen, germanium, aluminum, and zirconium in an amount of more than 4.0 mol % with respect to lithium and the metal element other than the different element contained in the positive active material, the element is not contained in the different elements. When the different element is present only on the surface of the positive active material, the content of the different element on the surface of the positive active material is preferably 4.0 mol % or less with respect to lithium and the metal element other than the different element contained in the positive active material.

The lower limit of the content of the different element is preferably 0.1 mol % or more and 3.0 mol % or less, more preferably 0.1 mol % or more and 2.0 mol % or less with respect to lithium and the metal element other than the different element contained in the positive active material. When the different element is boron, the lower limit of the content of the different element is more preferably 0.1 mol % or more and 2.0 mol % or less, still more preferably 0.1 mol % or more and 1.0 mol % or less with respect to lithium and the metal element other than the different element contained in the positive active material. When the surface of the positive active material contains two or more kinds of different elements, the total content is preferably 0.1 mol % or more and 4.0 mol % or less, and more preferably 0.1 mol % or more and 3.0 mol % or less. When the content of the different element is within the above range with respect to lithium and the metal element other than the different element contained in the positive active material, it is possible to further improve the effect of suppressing the increase in DC resistance associated with the charge-discharge cycle at a high temperature.

In the present invention, the contents of the dissimilar element other than nitrogen, and lithium and the metal element other than the different element contained in the positive active material are determined by inductively coupled plasma atomic emission spectrometry (ICP). The contents of the different element other than nitrogen and the metal element contained in the positive active material are measured by the following procedure. First, the positive active material is collected from the positive electrode in the completely discharged state by the above-described method, and the positive active material is entirely dissolved in an acid capable of dissolving the positive active material and the different element by a microwave decomposition method. Next, this solution is diluted with pure water to a certain amount to obtain a measurement solution. Then, using a multi-type ICP emission spectrometer ICPE-9820 (manufactured by Shimadzu Corporation), the concentration of the different element in the measurement solution and the concentration of the metal element contained in the positive active material are measured by ICP emission spectrophotometry. The contents of the different element and the metal element in the positive active material are quantified from the obtained concentration of the different element and the obtained concentration of the metal element contained in the positive active material. In the calculation of the concentration of the different element in the measurement solution and the concentration of the metal element contained in the positive active material, for example, a calibration curve method can be used in which a calibration curve is created from a solution having a known concentration of the different element and the metal element contained in the positive active material, and the concentration of the different element in the measurement solution and the concentration of the metal element contained in the positive active material are obtained. The nitrogen content is determined by an oxygen/nitrogen analyzer in the following procedure. The positive active material is collected from the positive electrode in the completely discharged state by the method described above, and nitrogen in the positive active material is extracted as nitrogen gas by an oxygen-nitrogen analyzer and detected by a thermal conductivity detector to quantify the nitrogen content. The presence of the different element on the surface of the positive active material can be confirmed, for example, by observing the surface of the positive active material with a scanning electron microscope-energy dispersive X-ray analyzer (SEM-EDX), an electron probe microanalyzer (EPMA), or the like.

The conductive agent is not particularly limited as long as the agent is a material with conductivity. Examples of such a conductive agent include carbonaceous materials, metals, and conductive ceramics. Examples of the carbonaceous materials include graphite, non-graphitic carbon, and graphene-based carbon. Examples of the non-graphitic carbon include carbon nanofibers, pitch-based carbon fibers, and carbon black. Examples of the carbon black include furnace black, acetylene black, and ketjen black. Examples of the graphene-based carbon include graphene, carbon nanotubes (CNTs), and fullerene. Examples of the form of the conductive agent include a powdery form and a fibrous form. As the conductive agent, one of these materials may be used alone, or two or more thereof may be used in mixture. In addition, these materials may be used in combination. For example, a composite material of carbon black and CNT may be used. Among these materials, carbon black is preferable from the viewpoints of electron conductivity and coatability, and in particular, acetylene black is preferable.

The content of the conductive agent in the positive active material layer is preferably 1% by mass or more and 10% by mass or less, more preferably 3% by mass or more and 9% by mass or less. The content of the conductive agent falls within the range mentioned above, thereby allowing the energy density of the energy storage device to be increased.

Examples of the binder mentioned above include: thermoplastic resins such as fluororesins (e.g., polytetrafluoroethylene (PTFE), polyvinylidene fluoride (PVDF)), polyethylene, polypropylene, polyacryl, and polyimide; elastomers such as an ethylene-propylene-diene rubber (EPDM), sulfonated EPDM, a styrene butadiene rubber (SBR), and a fluororubber; and polysaccharide polymers.

The content of the binder in the positive active material layer is preferably 1% by mass or more and 10% by mass or less, more preferably 2% by mass or more and 9% by mass or less. By setting the content of the binder in the above range, the active material can be stably held.

Examples of the thickener include polysaccharide polymers such as a carboxymethylcellulose (CMC) and a methylcellulose. When the thickener mentioned above has a functional group that is reactive with lithium and the like, the functional group may be deactivated by methylation or the like in advance.

The filler is not particularly limited. Examples of the filler include polyolefins such as polypropylene and polyethylene, inorganic oxides such as silicon dioxide, aluminum oxide, titanium dioxide, calcium oxide, strontium oxide, barium oxide, magnesium oxide and aluminosilicate, hydroxides such as magnesium hydroxide, calcium hydroxide and aluminum hydroxide, carbonates such as calcium carbonate, hardly soluble ionic crystals of calcium fluoride, barium fluoride, barium sulfate and the like, nitrides such as aluminum nitride and silicon nitride, and substances derived from mineral resources, such as talc, montmorillonite, boehmite, zeolite, apatite, kaolin, mullite, spinel, olivine, sericite, bentonite and mica, and artificial products thereof.

The positive active material layer may contain a typical nonmetal element such as B, N, P, F, Cl, Br, and I, a typical metal element such as Li, Na, Mg, Al, K, Ca, Zn, Ga, Ge, Sn, Sr, and Ba, or a transition metal element such as Sc, Ti, V, Cr, Mn, Fe, Co, Ni, Cu, Mo, Zr, Nb, and W as a component other than the positive active material, the conductive agent, the binder, the thickener, and the filler.

### (Negative Electrode)

The negative electrode has a negative substrate and a negative active material layer disposed directly on the negative substrate or over the negative substrate with an intermediate layer interposed therebetween. The configuration of the intermediate layer is not particularly limited, and can be selected from the configurations exemplified for the positive electrode, for example.

The negative substrate exhibits electrical conductivity. As the material of the negative substrate, a metal such as copper, nickel, stainless steel, nickel-plated steel, or aluminum, an alloy thereof, a carbonaceous material, or the like is used. Among these metals and alloys, the copper or copper alloy is preferable. Examples of the negative substrate include a foil, a deposited film, a mesh, and a porous material, and a foil is preferable from the viewpoint of cost. Accordingly, the negative substrate is preferably a copper foil or a copper alloy foil. Examples of the copper foil include a rolled copper foil and an electrolytic copper foil.

The average thickness of the negative substrate is preferably 2 μm or more and 35 μm or less, more preferably 3 μm or more and 30 μm or less, still more preferably 4 μm or more and 25 μm or less, particularly preferably 5 μm or more and 20 μm or less. By setting the average thickness of the negative substrate to the above range, it is possible to enhance the energy density per volume of a secondary battery while increasing the strength of the negative substrate.

The negative active material layer includes a negative active material. The negative active material layer contains optional components such as a conductive agent, a binder, a thickener, and a filler, if necessary. The optional components such as a conductive agent, a binder, a thickener, and a filler can be selected from the materials exemplified for the positive electrode.

The negative active material layer may contain a typical nonmetal element such as B, N, P, F, Cl, Br, and I, a typical metal element such as Li, Na, Mg, Al, K, Ca, Zn, Ga, Ge, Sn, Sr, and Ba, or a transition metal element such as Sc, Ti, V, Cr, Mn, Fe, Co, Ni, Cu, Mo, Zr, Ta, Hf, Nb, and W as a component other than the negative active material, the conductive agent, the binder, the thickener, and the filler.

The negative active material can be appropriately selected from known negative active materials. As the negative active material for a lithium ion secondary battery, a material capable of absorbing and releasing lithium ions is usually used. Examples of the negative active material include metallic Li; metals or metalloids such as Si and Sn; metal oxides or metalloid oxides such as a Si oxide, a Ti oxide, and a Sn oxide; titanium-containing oxides such as Li₄Ti₅O₁₂, LiTiO₂, and TiNb₂O₇; a polyphosphoric acid compound; silicon carbide; and carbon materials such as graphite and non-graphitic carbon (easily graphitizable carbon or hardly graphitizable carbon). Among these materials, graphite and non-graphitic carbon are preferable. In the negative active material layer, one of these materials may be used alone, or two or more thereof may be used in mixture.

The term “graphite” refers to a carbon material in which an average lattice spacing (d₀₀₂) of a (002) plane determined by X-ray diffraction before charge discharge or in a discharged state is 0.33 nm or more and less than 0.34 nm. Examples of the graphite include natural graphite and artificial graphite. Artificial graphite is preferable from the viewpoint that a material having stable physical properties can be procured.

The term “non-graphitic carbon” refers to a carbon material in which the average lattice spacing (d₀₀₂) of a (002) plane determined by X-ray diffraction before charge-discharge or in the discharged state is 0.34 nm or more and 0.42 nm or less. Examples of the non-graphitic carbon include hardly graphitizable carbon and easily graphitizable carbon. Examples of the non-graphitic carbon include a resin-derived material, a petroleum pitch or a material derived from petroleum pitch, a petroleum coke or a material derived from petroleum coke, a plant-derived material, and an alcohol-derived material.

In this regard, the “discharged state” of the carbon material means a state discharged such that lithium ions that can be occluded and released in association with charge-discharge are sufficiently released from the carbon material that is the negative active material. For example, the “discharged state” refers to a state where the open circuit voltage is 0.7 V or higher in a half cell that has, for use as a working electrode, a negative electrode containing a carbon material as a negative active material, and has metal Li for use as a counter electrode.

The term “hardly graphitizable carbon” refers to a carbon material in which the d₀₀₂ is 0.36 nm or more and 0.42 nm or less.

The term “easily graphitizable carbon” refers to a carbon material in which the d₀₀₂ is 0.34 nm or more and less than 0.36 nm.

The negative active material is typically particles (powder). The average particle size of the negative active material can be, for example, 1 nm or more and 100 μm or less. When the negative active material is a carbon material, a titanium containing oxide, or a polyphosphoric acid compound, the average particle size thereof may be 1 μm or more and 100 μm or less. When the negative active material is Si, Sn, an oxide of Si, an oxide of Sn, or the like, the average particle size thereof may be 1 nm or more and 1 μm or less. By setting the average particle size of the negative active material to be equal to or more than the lower limit mentioned above, the negative active material is easily produced or handled. By setting the average particle size of the negative active material to be equal to or less than the upper limit mentioned above, the electron conductivity of the active material layer is improved. A crusher, a classifier, or the like is used in order to obtain a powder with a predetermined particle size. The crushing method and classification method can be selected from, for example, the methods exemplified for the positive electrode. When the negative active material is a metal such as metal Li, the negative active material may have the form of a foil.

The content of the negative active material in the negative active material layer is preferably 60% by mass or more and 99% by mass or less, more preferably 90% by mass or more and 98% by mass or less. The content of the negative active material falls within the range mentioned above, thereby allowing a balance to be achieved between the increased energy density and productivity of the negative active material layer.

### (Separator)

The separator includes a substrate layer. The separator may further include an inorganic layer. An inorganic layer may be disposed between the positive active material layer and the substrate layer. As a form of the inorganic layer, an inorganic layer as a separator may be integrally formed on one surface or both surfaces of the substrate layer. When an inorganic layer harder than the substrate layer is disposed between the positive active material layer and the substrate layer, the contact between the positive active material and the different element present on the surface of the positive active material can be favorably maintained. The upper limit of the creep strain of the separator after holding a load of 2 MPa at a temperature of 65° C. for 60 seconds is 0.20, preferably 0.15, and more preferably 0.10. When the creep strain of the separator is equal to or less than the upper limit mentioned above, the contact between the positive active material and the different element can be favorably maintained. On the other hand, the lower limit of the creep strain of the separator may be, for example, 0. Note that the “load of 2 MPa at a temperature of 65° C.” is a relatively severe condition among loads that are predicted to be exposed to the negative active material layer, the separator, and the like in the case of the energy storage device used for power sources for automobiles such as electric vehicles (EV), hybrid vehicles (HEV) and plug-in hybrid vehicles (PHEV). When the creep strain of the separator under such conditions is within the above range, pores in the negative active material layer and the separator are not excessively compressed even when charge-discharge is repeated, and the effect of the present invention is sufficiently exhibited. The creep strain of the separator can be adjusted by changing the material of the substrate layer, the manufacturing method, the porosity, the pore size, the pore distribution, the pore shape, the thickness, the material of the inorganic layer when the separator includes the inorganic layer, the porosity, the porosity shape, the thickness, and the like.

The creep strain of the separator after holding a load of 2 MPa at a temperature of 65° C. for 60 seconds is a ratio of the amount of change in the thickness of the separator after holding a load of 2 MPa at a temperature of 65° C. for 60 seconds to the initial thickness of the separator, and is specifically a value measured by the following method. First, a thickness (A) of a sample obtained by stacking two hundred separators and not applied with a load at a temperature of 65° C. is measured. Next, the sample is compressed by pressing a cylindrical indenter having a diameter of 50 mm against the sample in the thickness direction of the sample using a load cell type creep tester (manufactured by MYS-TESTER Company Limited) at a temperature of 65° C. After the compressive stress reaches 2 MPa, the sample is held in this state for 60 seconds. A thickness (B) of the sample after holding the state where the stress is applied for 60 seconds is measured while holding the state where the stress is applied. From the thickness (A) of the sample in a state where no load is applied and the thickness (B) of the sample after a load of 2 MPa is held at a temperature of 65° C. for 60 seconds, the creep strain after holding a load of 2 MPa at a temperature of 65° C. for 60 seconds is determined by the following formula 2.

$$Creep strain = \{ ( A - B ) / A \} \qquad 2$$

A separator having creep strain in a suitable range can be appropriately selected from among known separators and used. As the separator, for example, a separator composed of only a resin substrate layer, a separator where an inorganic layer containing inorganic particles and a binder is formed on one surface or both surfaces of the resin substrate layer, or the like can be used. Examples of the form of the substrate layer of the separator include a woven fabric, a nonwoven fabric, and a porous resin film. Among these forms, a porous resin film is preferable from the viewpoint of strength.

Examples of the material for the substrate layer of the separator include polyolefins such as polyethylene and polypropylene, polyesters such as polyethylene terephthalate and polybutylene terephthalate, polyacrylonitrile, polyphenylene sulfide, polyimide, and fluororesin from the viewpoint of setting the creep strain of the separator within a suitable range, and among these, polyolefins are preferable.

As the substrate layer of the separator, a uniaxially stretched or biaxially stretched porous resin film can be used. Among them, a biaxially stretched porous resin film can be suitably used. Here, “uniaxial stretching” refers to stretching in only one direction (for example, machine direction) in the process of stretching a resin film at a temperature equal to or more than the glass-transition temperature to orient the molecules, and “biaxial stretching” refers to stretching in two orthogonal directions (for example, the machine direction and the transverse direction). The transverse direction refers to a direction parallel to the conveying surface of the resin film and orthogonal to the machine direction.

As a means for porositization in the step of producing the substrate layer of the separator, it is possible to use a dry substrate layer fabricated by adopting dry stretching in which stretching (for example, uniaxial stretching) is performed after drying, and a wet substrate layer fabricated by adopting wet stretching in which stretching (for example, biaxial stretching) is performed in a wet state (for example, a state where a resin as a raw material and a solvent are mixed). Among these, the wet substrate layer is preferable. From the above, the substrate layer of the separator is preferably a porous resin film produced by wet and biaxial stretching.

The lower limit of the porosity of the substrate layer of the separator is preferably 40% by volume, more preferably 45% by volume. Meanwhile, the upper limit of the porosity is preferably 65% by volume, more preferably 60% by volume. The “porosity” herein is a volume-based value, which means a value measured with a mercury porosimeter.

The pore size of the substrate layer of the separator is preferably 50 nm or more and 2,500 nm or less, more preferably 100 nm or more and 2,000 nm or less, still more preferably 150 nm or more and 1,500 nm or less.

The inorganic layer contains inorganic particles, and optionally contains a binder, a resin substrate, and the like. The inorganic layer may be provided by applying a paste containing inorganic particles and a binder to a surface of a substrate layer or the like, or may be formed by dispersing inorganic particles in a resin substrate formed from a thermoplastic resin. Since the inorganic particles contained in the inorganic layer are harder than the substrate layer, the inorganic layer can be harder than the substrate layer, and the contact between the positive active material and the different element present on the surface of the positive active material can be favorably maintained, so that the initial DC resistance can be reduced. The hardness of the inorganic particles and the substrate layer is evaluated by Vickers hardness.

Examples of the inorganic particles contained in the inorganic layer include oxides such as iron oxide, silicon oxide, aluminum oxide, titanium dioxide, zirconium oxide, calcium oxide, strontium oxide, barium oxide, magnesium oxide and aluminosilicate; nitrides such as aluminum nitride and silicon nitride; carbonates such as calcium carbonate; sulfates such as barium sulfate; hardly soluble ionic crystals such as calcium fluoride, barium fluoride, barium titanate; covalently bonded crystals such as silicon and diamond; and substances derived from mineral resources, such as talc, montmorillonite, zeolite, apatite, kaolin, mullite, spinel, olivine, sericite, bentonite, and mica, and artificial products thereof. As the inorganic particles, simple substances or complexes of these substances may be used alone, or two or more thereof may be used in mixture. Among these inorganic compounds, the silicon oxide, aluminum oxide, or aluminosilicate is preferable from the viewpoint of the safety of the energy storage device. The inorganic particles preferably have a mass loss of 5% or less in the case of temperature increase from room temperature to 500° C. under the air atmosphere of 1 atm, and more preferably have a mass loss of 5% or less in the case of temperature increase from room temperature to 800° C. Since these inorganic particles have a Vickers hardness higher than that of polyolefin and are hard, by applying the separator containing polyolefin as the substrate layer and the inorganic layer containing the above substances as inorganic particles, the effect of reducing initial DC resistance, which is the effect of the present invention, can be further improved.

Specific types of the binder for the inorganic layer include polyvinyl alcohol, polyvinyl ester, and the like in addition to those exemplified as the binder of the positive active material layer described above.

The thickness of the separator (total thickness of the substrate layer and the inorganic layer in the case of including the inorganic layer) is not particularly limited, and the lower limit of the thickness of the separator is preferably 5 μm, more preferably 10 μm. The upper limit of the thickness of the separator is preferably 40 μm, more preferably 30 μm.

When the separator has a resin substrate layer and an inorganic layer, the lower limit of the average thickness (the total average thickness when there are two or more inorganic layers in one separator) of the inorganic layer is preferably 1 μm, more preferably 3 μm. By setting the average thickness of the inorganic layer to be equal to or more than the lower limit mentioned above, the creep strain of the separator can be easily adjusted to a range of 0.20 or less. The upper limit of the average thickness of the inorganic layer is preferably 8 μm, more preferably 6 μm. The average thickness of the inorganic layer may be in a range of equal to or more than any of the above lower limits and equal to or less than any of the above upper limits.

### (Nonaqueous Electrolyte)

The nonaqueous electrolyte can be appropriately selected from known nonaqueous electrolytes. For the nonaqueous electrolyte, a nonaqueous electrolyte solution may be used. The nonaqueous electrolyte solution includes a nonaqueous solvent and an electrolyte salt dissolved in the nonaqueous solvent.

The nonaqueous solvent can be appropriately selected from known nonaqueous solvents. Examples of the nonaqueous solvent include cyclic carbonates, chain carbonates, carboxylic acid esters, phosphoric acid esters, sulfonic acid esters, ethers, amides, and nitriles. As the nonaqueous solvent, solvents in which some of the hydrogen atoms included in these compounds are substituted with halogen may be used.

Examples of the cyclic carbonates include ethylene carbonate (EC), propylene carbonate (PC), butylene carbonate (BC), vinylene carbonate (VC), vinylethylene carbonate (VEC), chloroethylene carbonate, fluoroethylene carbonate (FEC), difluoroethylene carbonate (DFEC), styrene carbonate, 1-phenylvinylene carbonate, and 1,2-diphenylvinylene carbonate. Among these carbonates, EC is preferable.

Examples of the chain carbonates include diethyl carbonate (DEC), dimethyl carbonate (DMC), ethyl methyl carbonate (EMC), diphenyl carbonate, trifluoroethyl methyl carbonate, and bis(trifluoroethyl) carbonate. Among these carbonates, EMC is preferable.

As the nonaqueous solvent, it is preferable to use the cyclic carbonate or the chain carbonate, and it is more preferable to use the cyclic carbonate and the chain carbonate in combination. The use of the cyclic carbonate allows the promoted dissociation of the electrolyte salt to improve the ionic conductivity of the nonaqueous electrolyte solution. The use of the chain carbonate allows the viscosity of the nonaqueous electrolyte solution to be kept low. When the cyclic carbonate and the chain carbonate are used in combination, the volume ratio of the cyclic carbonate to the chain carbonate (cyclic carbonate:chain carbonate) preferably falls within the range from 5:95 to 50:50, for example.

The electrolyte salt can be appropriately selected from known electrolyte salts. Examples of the electrolyte salt include a lithium salt, a sodium salt, a potassium salt, a magnesium salt, and an onium salt. Among these salts, the lithium salt is preferable.

Examples of the lithium salt include inorganic lithium salts such as LiPF₆, LiPO₂F₂, LiBF₄, LiClO₄, and LiN(SO₂F)₂, lithium oxalates such as lithium bis(oxalate)borate (LiBOB), lithium difluorooxalatoborate (LiFOB), and lithium bis(oxalate)difluorophosphate (LiFOP), and lithium salts having a halogenated hydrocarbon group, such as LiSO₃CF₃, LiN(SO₂CF₃)₂, LiN(SO₂C₂F₅)₂, LiN(SO₂CF₃)(SO₂C₄F₉), LiC(SO₂CF₃)₃, and LiC(SO₂C₂F₅)₃. Among these salts, the inorganic lithium salts are preferable, and LiPF₆ is more preferable.

The content of the electrolyte salt in the nonaqueous electrolyte solution is, at 20° C. under 1 atm, preferably 0.1 mol/dm³ or more and 2.5 mol/dm³ or less, more preferably 0.3 mol/dm³ or more and 2.0 mol/dm³ or less, still more preferably 0.5 mol/dm³ or more and 1.7 mol/dm³ or less, particularly preferably 0.7 mol/dm³ or more and 1.5 mol/dm³ or less. The content of the electrolyte salt falls within the range mentioned above, thereby allowing the ionic conductivity of the nonaqueous electrolyte solution to be increased.

The nonaqueous electrolyte solution may include an additive, besides the nonaqueous solvent and the electrolyte salt. Examples of the additive include oxalic acid salts such as lithium bis(oxalate)borate (LiBOB), lithium difluorooxalatoborate (LiFOB), and lithium bis(oxalate)difluorophosphate (LiFOP); imide salts such as lithium bis(fluorosulfonyl)imide (LiFSI); aromatic compounds such as biphenyl, alkylbiphenyl, terphenyl, partly hydrogenated terphenyl, cyclohexylbenzene, t-butylbenzene, t-amylbenzene, diphenyl ether, and dibenzofuran; partial halides of the aromatic compounds, such as 2-fluorobiphenyl, o-cyclohexylfluorobenzene, and p-cyclohexylfluorobenzene; halogenated anisole compounds such as 2,4-difluoroanisole, 2,5-difluoroanisole, 2,6-difluoroanisole, and 3,5-difluoroanisole; vinylene carbonate, methylvinylene carbonate, ethylvinylene carbonate, succinic anhydride, glutaric anhydride, maleic anhydride, citraconic anhydride, glutaconic anhydride, itaconic anhydride, cyclohexanedicarboxylic anhydride; ethylene sulfite, propylene sulfite, dimethyl sulfite, methyl methanesulfonate, busulfan, methyl toluenesulfonate, dimethyl sulfate, ethylene sulfate, sulfolane, dimethyl sulfone, diethyl sulfone, dimethylsulfoxide, diethylsulfoxide, tetramethylene sulfoxide, diphenyl sulfide, 4,4′-bis(2,2-dioxo-1,3,2-dioxathiolane, 4-methylsulfonyloxymethyl-2,2-dioxo-1,3,2-dioxathiolane, thioanisole, diphenyl disulfide, dipyridinium disulfide, 1,3-propene sultone, 1,3-propane sultone, 1,4-butane sultone, 1,4-butene sultone, perfluorooctane, tristrimethylsilyl borate, tristrimethylsilyl phosphate, tetrakistrimethylsilyl titanate, lithium monofluorophosphate, and lithium difluorophosphate. One of these additives may be used alone, or two or more thereof may be used in mixture.

The content of the additive contained in the nonaqueous electrolyte solution is preferably 0.01% by mass or more and 10% by mass or less, more preferably 0.1% by mass or more and 7% by mass or less, still more preferably 0.2% by mass or more and 5% by mass or less, particularly preferably 0.3% by mass or more and 3% by mass or less, with respect to a total mass of the nonaqueous electrolyte solution. The content of the additive falls within the range mentioned, thereby making it possible to improve capacity retention performance or cycle performance after high-temperature storage, and to further improve safety.

For the nonaqueous electrolyte, a solid electrolyte may be used, or a nonaqueous electrolyte solution and a solid electrolyte may be used in combination.

The solid electrolyte can be selected from arbitrary materials with ionic conductivity, which are solid at normal temperature (for example, 15° C. to 25° C.), such as lithium, sodium, and calcium. Examples of the solid electrolyte include a sulfide solid electrolyte, an oxide solid electrolyte, an oxynitride solid electrolyte, polymer solid electrolyte, and a gel polymer electrolyte.

Examples of the sulfide solid electrolyte include Li₂S—P₂S₅, LiI—Li₂S—P₂S₅, and Li₁₀Ge—P₂S₁₂ in the case of a lithium ion secondary battery.

### (Application of Load on Electrode Assembly)

The electrode assembly is in a state where a load is applied to the electrode assembly in the stacking direction. This makes it possible to maintain the contact between the positive active material and the different element present on the surface even when the charge-discharge cycle is performed at a high temperature. The electrode assembly housed in the case can be brought into the state where the load is applied from the outside of the case, that is, via the case. The load is applied to the electrode assembly in a direction in which the positive electrode, the negative electrode, and the separator are overlapped with each other (thickness direction of each layer). That is, the load is applied in a direction in which the positive active material layer and the negative active material layer are crushed in the stacking direction. However, no load may be applied to a part of the electrode assembly (for example, a pair of curved parts or the like of a flattened wound-type electrode assembly). In addition, the load may be applied to a stacked electrode assembly and only a part of a flat part of a flattened wound-type electrode assembly.

The lower limit of the pressure applied to the electrode assembly in the state where the load is applied to the electrode assembly in the stacking direction is preferably 0.1 MPa and more preferably 0.2 MPa. By applying the load to the electrode assembly at a pressure equal to or more than the lower limit mentioned above, a contact property between the positive active material and the different element present on the surface can be improved. The upper limit of the pressure applied to the electrode assembly may be, for example, 5 MPa, and may be 2 MPa, 1 MPa, 0.5 MPa, or 0.3 MPa. By applying the load to the electrode assembly at a pressure equal to or less than the upper limit mentioned above, clogging or the like of the separator can be suppressed, and charge-discharge performance can be enhanced.

The pressurization (application of a load) to the electrode assembly can be performed by, for example, a pressurizing member that pressurizes the case from the outside. The pressurizing member may be a restraining member that restrains the shape of the case. The pressurizing member (restraining member) is provided so as to sandwich and then pressurize the electrode assembly from both surfaces in the stacking direction via the case, for example. The surfaces of the electrode assembly to be pressurized have contact with the inner surface of the case directly or with another member interposed therebetween. Thus, the electrode assembly is pressurized by pressurizing the case. Examples of the pressurizing member include a restraining band or a metallic frame. For example, a metallic frame may be configured to apply an adjustable load with a bolt or the like. In addition, a plurality of secondary batteries (energy storage devices) may be arranged side by side in the stacking direction of the electrode assembly, and fixed with the use of a frame or the like with the plurality of secondary batteries pressurized from both ends in the stacking direction.

The shape of the energy storage device according to the present embodiment is not to be considered particularly limited, and examples thereof include cylindrical batteries, prismatic batteries, flattened batteries, coin batteries and button batteries.

FIG. 1 illustrates an energy storage device 1 as an example of a prismatic battery. It is to be noted that FIG. 1 is a view illustrating the inside of a case in a perspective manner. An electrode assembly 2 including a positive electrode and a negative electrode wound with a separator interposed therebetween is housed in a prismatic case 3. The positive electrode is electrically connected to a positive electrode terminal 4 via a positive electrode lead 41. The negative electrode is electrically connected to a negative electrode terminal 5 via a negative electrode lead 51.

### <Configuration of Energy Storage Apparatus>

The energy storage device according to the present embodiment can be mounted as an energy storage unit (battery module) configured with a plurality of energy storage devices assembled, on power sources for automobiles such as electric vehicles (EV), hybrid vehicles (HEV), and plug-in hybrid vehicles (PHEV), power sources for electronic devices such as personal computers and communication terminals, power sources for power storage, or the like. In this case, the technique of the present invention may be applied to at least one energy storage device included in the energy storage unit. An energy storage apparatus according to an embodiment of the present invention includes two or more energy storage devices, and includes one or more energy storage devices according to an embodiment of the present invention (hereinafter, referred to as “second embodiment”). The technique according to an embodiment of the present invention may be applied to at least one energy storage device included in the energy storage apparatus according to the second embodiment, and the energy storage apparatus may include one energy storage device according to an embodiment of the present invention and include one or more energy storage devices not according to an embodiment of the present invention, or may include two or more energy storage devices according to an embodiment of the present invention.

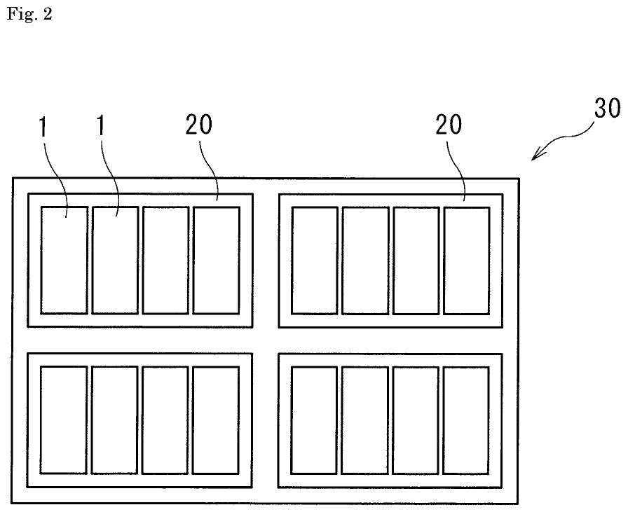

FIG. 2 illustrates an example of an energy storage apparatus 30 according to the second embodiment, obtained by further assembling energy storage units 20 that each have two or more electrically connected energy storage devices 1 assembled. The energy storage apparatus 30 may include a busbar (not illustrated) that electrically connects two or more energy storage devices 1, a busbar (not illustrated) that electrically connects two or more energy storage units 20, and the like. The energy storage unit 20 or the energy storage apparatus 30 may include a state monitor (not illustrated) that monitors the state of one or more energy storage devices 1.

### <Method for Manufacturing Energy Storage Device>

A method for manufacturing the energy storage device according to the present embodiment can be appropriately selected from known methods. The manufacturing method includes, for example, preparing an electrode assembly, preparing a nonaqueous electrolyte, and housing the electrode assembly and the nonaqueous electrolyte in a case. The preparation of the electrode assembly includes: preparing a positive electrode and a negative electrode, and forming an electrode assembly by stacking or winding the positive electrode and the negative electrode with a separator, having a creep strain of 0.20 or less, interposed therebetween. The preparation of the electrode assembly may further include interposing an inorganic layer between the positive active material layer and the separator.

The positive electrode can be fabricated, for example, by applying a positive composite paste to a positive substrate directly or with an intermediate layer interposed therebetween, and drying the paste. After the drying, pressing or the like may be performed, if necessary. The positive composite paste contains components constituting the positive active material layer such as the positive active material, and a conductive aid or a binder as an optional component. The positive composite paste typically further includes a dispersion medium. Examples of the method of making tungsten, boron, sulfur, phosphorus, silicon, titanium, nitrogen, germanium, aluminum, zirconium, or a different element which is a combination thereof present on the surface of the positive active material include a method in which positive active material particles are impregnated with a solution containing ions and the like of the different element, a method in which the solution containing ions and the like of the different element is sprayed onto the positive active material particles, and a method in which the positive active material particles and a compound containing the different element are mixed. Heat treatment may be performed after the method of making the different element present. In addition, the method of making the different element present is performed before preparing the positive composite paste.

Housing the nonaqueous electrolyte in the case can be appropriately selected from known methods. For example, in the case of using a nonaqueous electrolyte solution for the nonaqueous electrolyte, the nonaqueous electrolyte solution is injected from an inlet formed in the case, followed by sealing the inlet. The method for manufacturing the energy storage device may further include attaching a pressurizing member such as a binding member. Details of each member constituting the energy storage device are as described above.

The energy storage device of the present embodiment can suppress the increase in DC resistance associated with the charge-discharge cycle at a high temperature.

### Other Embodiments

The nonaqueous electrolyte energy storage device according to the present invention is not limited to the embodiment described above, and various changes may be made without departing from the gist of the present invention. For example, to the configuration of one embodiment, the configuration of another embodiment can be added, and a part of the configuration of one embodiment can be replaced by the configuration of another embodiment or a well-known technique. Furthermore, a part of the configuration according to one embodiment can be deleted. In addition, a well-known technique can be added to the configuration of one embodiment.

In the embodiment, a case where the nonaqueous electrolyte energy storage device is used as a nonaqueous electrolyte secondary battery (for example, lithium ion secondary battery) that is chargeable and dischargeable has been described, but the type, shape, dimensions, capacity, and the like of the nonaqueous electrolyte energy storage device are arbitrary. The present invention can also be applied to capacitors such as various secondary batteries, electric double layer capacitors, or lithium ion capacitors.

### EXAMPLES

Hereinafter, the present invention will be described more specifically with reference to examples. The present invention is not limited to the following Examples.

### Example 1

### (Fabrication of Positive Electrode)

A positive composite paste was prepared with the use of LiNi_{1/3}Co_{1/3}Mn_{1/3}O₂ as a positive active material, acetylene black (AB) as a conductive agent, a polyvinylidene fluoride (PVDF) as a binder, and an N-methylpyrrolidone (NMP) as a dispersion medium. It is to be noted that the mass ratio of the positive active material, the conductive agent, and the binder was set to 93:4:3 (in terms of solid content). As the positive active material, one in which tungsten was previously present as the different element on the surface was used. A tungsten compound (WO₃) was used as the different element, so that at least a part of the surface of the positive active material was covered (coated). The content of tungsten as the different element was 1.0 mol % with respect to lithium and the metal element other than the different element contained in the positive active material. The positive composite paste was applied to both surfaces of an aluminum foil as a positive substrate, and dried. Thereafter, roll pressing was performed to obtain a positive electrode. A coat weight of the positive active material layer was 1.4 g/100 cm². The coat weight of the positive active material layer is a total value of two layers provided on both surfaces of the positive electrode substrate.

### (Fabrication of Negative Electrode)

Graphite as a negative active material, a styrene-butadiene rubber (SBR) as a binder, carboxymethyl cellulose (CMC) as a thickener, and water as a dispersion medium were mixed to prepare a negative composite paste. It is to be noted that the mass ratio of the negative active material, the binder, and the thickener was set to 98:1:1 (in terms of solid content). The negative composite paste was applied to both surface of a copper foil as a negative substrate, and dried. Thereafter, roll pressing was performed to obtain a negative electrode. The coat weight of the negative active material layer was 0.85 g/100 cm². The coat weight of the negative active material layer is a total value of two layers provided on both surfaces of the negative electrode substrate.

### (Nonaqueous Electrolyte Solution)

LiPF₆ was dissolved at a concentration of 1.0 mol/dm³ in a solvent obtained by mixing an ethylene carbonate, a dimethyl carbonate, and an ethyl methyl carbonate at a volume ratio of 30:35:35 to obtain a nonaqueous electrolyte solution.

### (Separator)

As a separator, one in which an inorganic layer containing aluminum oxide as inorganic particles and polyvinyl alcohol as a binder was formed on one surface of a substrate layer formed of a wet-biaxially stretched polyolefin porous resin film was used. The separator had a porosity of 55% by volume and a thickness of 15 μm. The creep strain of the separator of Example 1 measured by the method described above was 0.19 after a load of 2 MPa was held at a temperature of 65° C. for 60 seconds.

### (Assembly of Battery)

The positive electrode, the negative electrode, and the separator were used to obtain a wound electrode assembly. The inorganic layer of the separator was opposed to the positive electrode. The electrode assembly was housed in a prismatic case, and a nonaqueous electrolyte solution was injected to seal the case. The energy storage device of Example 1 was obtained in a state where the case was pressurized from both surfaces thereof with the pressurizing member such that the load applied to the electrode assembly was 0.5 MPa.

### Examples 2 to 4 and Comparative Examples 1 to 13

Each energy storage device of Examples 2 to 4 and Comparative Examples 1 to 13 was obtained similarly to Example 1 except that the kind of the different element present on the surface of the positive active material, the load applied to the electrode assembly, and the creep strain of the separator after holding a load of 2 MPa at a temperature of 65° C. for 60 seconds were changed as shown in Table 1.

At least a part of the surface of the positive active material was covered (coated) with the tungsten compound (WO₃) in the positive active materials of Example 2, Example 3, and Comparative Examples 5 to 7, and with the boron compound (H₃BO₃) in the positive active materials of Example 4 and Comparative Example 13. In addition, in the positive active materials of Comparative Examples 1 to 4 and Comparative Examples 8 to 11, those in which no different element was present on the surface were used. “-” in Table 1 indicates that no different element is present.

As the separators of Comparative Examples 2 and 9, the same separators as in Example 1 were used. As the separators of Example 2, Comparative Example 3, Comparative Example 6, and Comparative Example 10, wet biaxially stretched porous resin film separators were used. The separators of Example 2, Comparative Example 3, Comparative Example 6, and Comparative Example 10 had a porosity of 46% by volume and a thickness of 15 μm. As the separators of Example 3, Example 4, Comparative Example 4, Comparative Example 7, and Comparative Example 11, wet biaxially stretched porous resin film separators were used. The separators of Example 3, Example 4, Comparative Example 4, Comparative Example 7, and Comparative Example 11 had a porosity of 42% by volume and a thickness of 15 μm. As the separators of Comparative Example 1, Comparative Example 5, Comparative Example 8, Comparative Example 12, and Comparative Example 13, wet biaxially stretched porous resin film separators were used. The separators of Comparative Example 1, Comparative Example 5, Comparative Example 8, Comparative Example 12, and Comparative Example 13 had a porosity of 60% by volume and a thickness of 20 μm. The creep strain of each separator after a load of 2 MPa was held at a temperature of 65° C. for 60 seconds was shown in Table 1.

### Example 5

An energy storage device of Example 5 was obtained similarly to Example 1 except that as a separator, one in which an inorganic layer containing aluminum oxide as inorganic particles and polyvinyl alcohol as a binder was formed on one surface of a substrate layer including a dry-uniaxially stretched polyolefin microporous film having a thickness of 20 μm and a porosity of 55% was used. The inorganic layer of the separator was opposed to the positive electrode.

### Example 6 and Comparative Examples 14 to 17

Each energy storage device of Example 6 and Comparative Examples 14 to 17 was obtained similarly to Example 5 except that the kind of the different element present on the surface of the positive active material, the load applied to the electrode assembly, and an opposing surface of the inorganic layer of the separator were changed as shown in Table 2. “-” in Table 2 indicates that no different element is present.

### [Evaluation]

### (Initial Charge-Discharge)

Each energy storage device obtained was subjected to constant current charge up to 4.1 V at a charge current of 0.2 C at 25° C., and then to constant voltage charge at 4.1 V. The charge termination condition was set to 7 hours after the start of charge. After a pause period of 10 minutes was provided, the energy storage device was subjected to constant current discharge to 3.0 V at a discharge current of 1.0 C, and a pause period of 10 minutes was further provided. The charging and discharging constituted one cycle, and initial charge-discharge of two cycles was performed.

### (Initial DC Resistance)

Each energy storage device after the initial charge-discharge was subjected to constant current charge at a current of 0.2 C at 25° C. to set the SOC to 50%. The energy storage device was stored in a thermostatic bath at −10° C. for 3 hours, and then discharged at a constant current of 0.2 C, 0.5 C, or 1.0 C at −10° C. for 30 seconds. After completion of each discharge, constant current charge was performed at a current of 0.05 C to set the SOC to 50%. The relationship between the current in each discharge and the voltage at 10 seconds after the start of discharge was plotted, and the DC resistance was determined from the slope of a straight line obtained from the plot of 3 points and taken as the initial DC resistance. A relative ratio [%] of the initial DC resistance of each of the energy storage devices of Example 5, Example 6, and Comparative Examples 14 to 17 when the initial DC resistance of Comparative Example 14 is taken as 100% is determined and shown in Table 2.

### (Charge-Discharge Cycle Test)

Then, each of the energy storage devices of Examples 1 to 4 and Comparative Examples 1 to 13 was subjected to the following charge-discharge cycle test. The energy storage device was stored in a thermostatic bath at 60° C. for 3 hours, and then subjected to constant current charge at a constant current of 8.0 C to SOC 85% at 60° C. Thereafter, constant current discharge was performed up to SOC 15% at a discharge current of 8.0 C without providing a pause period. The charging and discharging steps constituted one cycle, and the cycle was performed 4290 cycles.

(Rate of Increase in DC Resistance after Charge-Discharge Cycle Test)

Each of the energy storage devices of Examples 1 to 4 and Comparative Examples 1 to 13 after the charge-discharge cycle test was subjected to constant current charge at a current of 0.2 C at 25° C. to set the SOC to 50%. The energy storage device was stored in a thermostatic bath at −10° C. for 3 hours, and then discharged at a constant current of 0.2 C, 0.5 C, or 1.0 C at −10° C. for 30 seconds. After completion of each discharge, constant current charge was performed at a current of 0.05 C to set the SOC to 50%. The relationship between the current in each discharge and the voltage at 10 seconds after the start of discharge was plotted, and the DC resistance was determined from the slope of a straight line obtained from the plot of 3 points and taken as the DC resistance after the charge-discharge cycle. By dividing the DC resistance after the charge-discharge cycle by the initial DC resistance, a rate of increase in DC resistance after the charge-discharge cycle of each of the energy storage devices of Examples 1 to 4 and Comparative Examples 1 to 13 was obtained, and is shown in Table 1.

TABLE 1

| | | | | Evaluation |
|---|---|---|---|---|
| | Positive | | | DC resistance |
| | active | | Load applied | increase rate |
| | material | | to electrode | after charge- |
| | Different | Separator | assembly | discharge cycle |
| | element | Creep strain | [MPa] | [%] |
| Comparative | — | 0.23 | 0.0 | 90 |
| Example 1 | | | | |
| Comparative | — | 0.19 | 0.0 | 96 |
| Example 2 | | | | |
| Comparative | — | 0.13 | 0.0 | 99 |
| Example 3 | | | | |
| Comparative | — | 0.08 | 0.0 | 96 |
| Example 4 | | | | |
| Comparative | Tungsten | 0.23 | 0.0 | 90 |
| Example 5 | | | | |
| Comparative | Tungsten | 0.13 | 0.0 | 97 |
| Example 6 | | | | |
| Comparative | Tungsten | 0.08 | 0.0 | 100 |
| Example 7 | | | | |
| Comparative | — | 0.23 | 0.5 | 87 |
| Example 8 | | | | |
| Comparative | — | 0.19 | 0.5 | 86 |
| Example 9 | | | | |
| Comparative | — | 0.13 | 0.5 | 86 |
| Example 10 | | | | |
| Comparative | — | 0.08 | 0.5 | 86 |
| Example 11 | | | | |
| Comparative | Tungsten | 0.23 | 0.5 | 87 |
| Example 12 | | | | |
| Example 1 | Tungsten | 0.19 | 0.5 | 84 |
| Example 2 | Tungsten | 0.13 | 0.5 | 79 |
| Example 3 | Tungsten | 0.08 | 0.5 | 78 |
| Comparative | Boron | 0.23 | 0.5 | 85 |
| Example 13 | | | | |
| Example 4 | Boron | 0.08 | 0.5 | 82 |

As shown in Table 1, in Examples 1 to 4 in which the electrode assembly was in the state where the load was applied to the electrode assembly in the stacking direction, the different element was present on the surface of the positive active material, and the creep strain after a load of 2 MPa was held for 60 seconds at a temperature of 65° C. in the separator was 0.20 or less, the DC resistance increase rate was 84% or less, and a high suppressing effect on the increase in DC resistance associated with the charge-discharge cycle at a high temperature was obtained. On the other hand, in Comparative Examples 1 to 7 in which no load was applied to the electrode assembly in the stacking direction, regardless of the presence or absence of the different element on the surface of the positive active material, the DC resistance increase rate of Comparative Examples 2 to 4 and Comparative Examples 6 and 7 in which the creep strain after a load of 2 MPa was held for 60 seconds at a temperature of 65° C. in the separator was 0.20 or less is higher than that of Comparative Example 1 and 5 in which the creep strain after a load of 2 MPa was held for 60 seconds at a temperature of 65° C. in the separator was more than 0.20, and the tendency opposite to that in Examples 1 to 4 was observed. Even in the state where the load was applied to the electrode assembly in the stacking direction, in Comparative Examples 8 to 11 in which no different element was present on the surface of the positive active material and Comparative Examples 12 and 13 in which the creep strain after a load of 2 MPa was held for 60 seconds at a temperature of 65° C. in the separator was more than 0.20, the suppressing effect on the increase in DC resistance was lower than that in Examples 1 to 4.

TABLE 2

| | | | | Evaluation |
|---|---|---|---|---|
| | | | | Relative ratio |
| | Positive | | | of initial DC |
| | active | Separator | Load applied | resistance to |
| | material | Opposing | to electrode | Comparative |
| | Different | surface of | assembly | Example 1 |
| | element | inorganic layer | [MPa] | [%] |
| Comparative | — | Positive | 0.0 | 100 |
| Example 14 | | electrode | | |
| Comparative | — | Positive | 0.5 | 89 |
| Example 15 | | electrode | | |
| Comparative | — | Negative | 0.5 | 90 |
| Example 16 | | electrode | | |
| Comparative | Tungsten | Positive | 0.0 | 88 |
| Example 17 | | electrode | | |
| Example 5 | Tungsten | Positive | 0.5 | 73 |
| | | electrode | | |
| Example 6 | Tungsten | Negative | 0.5 | 81 |
| | | electrode | | |

As shown in Table 2, in Example 5 in which the electrode assembly was in the state where the load was applied to the electrode assembly in the stacking direction, the different element was present on the surface of the positive active material, and the inorganic layer was disposed between the positive active material layer and the substrate layer, the relative ratio of the initial DC resistance at −10° C. to that of Comparative Example 14 was 73%, and a high reduction effect with respect to the initial DC resistance at a low temperature was obtained. On the other hand, in Comparative Examples 14 to 17 in which no different element was present on the surface of the positive active material or no load was applied to the electrode assembly in the stacking direction, the reduction effect with respect to the initial DC resistance was very low. In Example 5, even when the different element was present on the surface of the positive active material and the load was applied to the electrode assembly in the stacking direction, the reduction effect with respect to the initial DC resistance was higher than that of Example 6 in which the inorganic layer did not face the positive electrode.

As a result, it was shown that the energy storage device could suppress the increase in resistance associated with the charge-discharge cycle at a high temperature.

### INDUSTRIAL APPLICABILITY

The present invention can be applied to an energy storage device used as a power source for electronic devices such as personal computers and communication terminals, motor vehicles, and the like.

### DESCRIPTION OF REFERENCE SIGNS

1: Energy storage device
2: Electrode assembly
3: Case
4: Positive electrode terminal
41: Positive electrode lead
5: Negative electrode terminal
51: Negative electrode lead
20: Energy storage unit
30: Energy storage apparatus

1. An energy storage device comprising an electrode assembly in which a positive electrode and a negative electrode are stacked with a separator interposed therebetween, wherein
the electrode assembly is in a state where a load is applied to the electrode assembly in a stacking direction,
the positive electrode contains a positive active material,
tungsten, boron, sulfur, phosphorus, silicon, titanium, nitrogen, germanium, aluminum, zirconium or a different element which is a combination thereof is present on a surface of the positive active material, and
a creep strain after a load of 2 MPa is held for 60 seconds at a temperature of 65° C. in the separator is 0.20 or less.

2. The energy storage device according to claim 1, wherein a pressure applied to the electrode assembly is 0.1 MPa or more.

3. The energy storage device according to claim 1, wherein a content of the different element is 0.1 mol % or more and 3.0 mol % or less with respect to lithium and a metal element other than the different element contained in the positive active material.

4. The energy storage device according to claim 1, wherein the separator includes a substrate layer, the positive electrode includes a positive active material layer containing the positive active material, and an inorganic layer is disposed between the positive active material layer and the substrate layer.

5. An energy storage apparatus comprising two or more energy storage devices, and comprising one or more energy storage devices according to claim 1.
